(19) United States
(12) Patent Application Publication
(10) Pub. No.: US 2023/0392625 A1
(43) Pub. Date: Dec. 7, 2023

(54) SEAM CONSTRUCTION ON SEMI-RIGID PANEL

(71) Applicant: Sabin, LLC, Chicago, IL (US)

(72) Inventors: Samuel Riehl, Chicago, IL (US); Lucas Baird, Chicago, IL (US); Wes Cox, Chicago, IL (US)

(73) Assignee: Sabin, LLC, Chicago, IL (US)

(21) Appl. No.: 18/320,023

(22) Filed: May 18, 2023

Related U.S. Application Data
(60) Provisional application No. 63/343,400, filed on May 18, 2022.

(51) Int. Cl. F16B 5/00; G10K 11/162

(52) U.S. Cl. CPC F16B 5/0056; G10K 11/162

(57) ABSTRACT

Embodiments disclosed herein describe a semi-rigid fibrous body. The semi-rigid fibrous body includes a first body portion; a second body portion; a partial depth incision in the semi-rigid fibrous body between the first body portion and the second body portion; a third body portion; and two “V” shaped reliefs cut into the semi-rigid fibrous body between the second body portion and the third body portions, where the partial depth incision and the two “V” shaped reliefs are living hinges formed of the semi-rigid fibrous body.

### CROSS-REFERENCE TO RELATED APPLICATIONS

This patent application claims the benefit of U.S. Provisional Patent Application No. 63/343,400, filed May 18, 2022, which is incorporated by reference.

### BACKGROUND

Semi-rigid fibrous materials provide acoustic dampening properties that are advantageous in certain environments. Accordingly, building common structures, such as lighting structures within such environments using semi-rigid fibrous materials is advantageous from an acoustics perspective. Typically, these structures with preferred acoustic properties are constructed using a metal (or other such rigid material) frame with the semi-rigid fibrous materials attached to the frame using an adhesive or fasteners/hardware devices. Working with adhesives and/or the fasteners/hardware devices is less desirable and the use of a rigid frame adds unwanted expense. Although, simply removing the adhesive and/or the fasteners/hardware devices and rigid frame presents several inherent issues such as joining bodies and creating structure when working with semi-rigid fibrous materials. In application, both are often necessary to build a final product i.e., maintaining vertical or horizontal planarity and creating a ledge on to which another part is attached/sits.

### BRIEF DESCRIPTION OF THE SEVERAL VIEWS OF THE DRAWING(S)

FIG. 1 illustrates a perspective view of a Z seam for providing structural support in semi-rigid fibrous material, in accordance with embodiments of the disclosure;

FIG. 2 illustrates a side view of the Z seam of FIG. 1;

FIG. 3 illustrates an unfolded embodiment of the Z seam of FIGS. 1 and 2;

FIG. 4 illustrates a perspective view of a Z seam with side joint tabs, in accordance with embodiments of the disclosure;

FIG. 5 illustrates a G seam for providing structural support in semi-rigid fibrous material, in accordance with embodiments of the disclosure;

FIG. 6 illustrates a side view of the G seam of FIG. 5;

FIG. 7 illustrates an unfolded embodiment of the G seam of FIGS. 5 and 6;

FIG. 8 illustrates a perspective view of a G seam with side joint tabs, in accordance with embodiments of the disclosure;

FIG. 9 illustrates a perspective view of the C seam for providing structural support in semi-rigid fibrous material, in accordance with embodiments of the disclosure;

FIG. 10 illustrates a side view of the C seam of FIG. 9;

FIG. 11 illustrates a perspective view of an unfolded embodiment of the C seam of FIGS. 9 and 10;

FIG. 12 illustrates a side view of the unfolded embodiment of the C seam of FIG. 11;

FIGS. 13a and 13b illustrates a perspective view of a retaining structure formed from a seam, in accordance with embodiments of the disclosure; and

FIGS. 14a and 14b illustrates a perspective view of a retaining structure formed from a seam, in accordance with embodiments of the disclosure.

### DETAILED DESCRIPTION OF THE INVENTION

Embodiments of the present disclosure provide techniques for forming semi-rigid fibrous material in a manner that provides needed structure and the ability to align and join multiple pieces of semi-rigid fibrous material. While two seam embodiments are described below, other such embodiments are contemplated that may contain more or less layers and cuts in the semi-rigid fibrous material in order to form the layers and folds. Regarding the described embodiments below, both constructions create rigidity along lengths of semi-rigid materials as well as enable tertiary features functioning in capacities such as but not limited to aligning, joining, attaching, sinching, closing, or capturing.

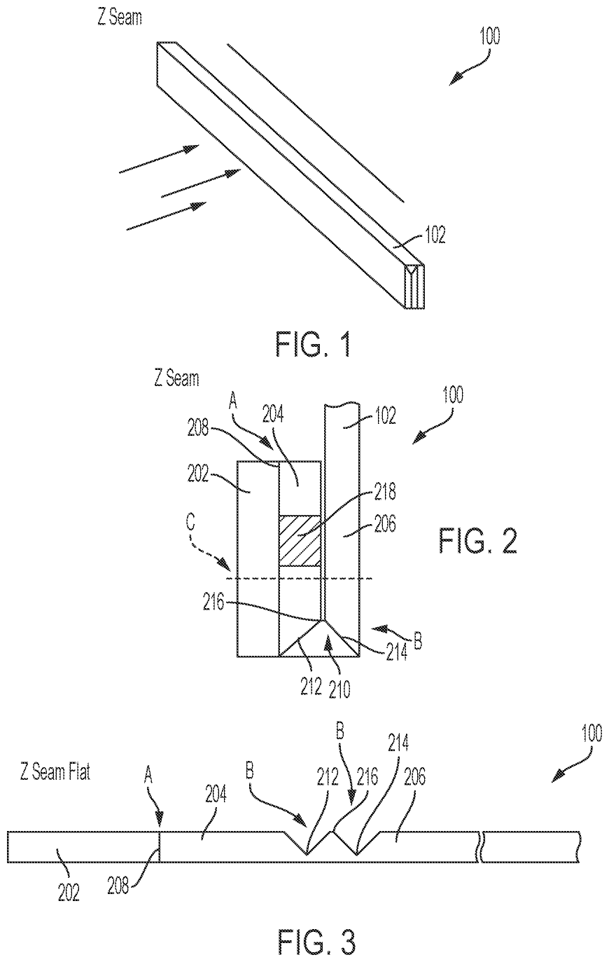

FIG. 1 illustrates a perspective view of a Z seam support structure (Z seam for short) 100, in accordance with embodiments of the disclosure. Z seam 100 is formed using semi-rigid fibrous material 102 folded in a manner to increase the structural rigidity by reinforcing the semi-rigid fibrous material 102 with multiple layers. This structural rigidity using the Z seam 100 is improved in both the lengthwise and perpendicular directions.

FIG. 2 illustrates a side view of the Z seam 100 of FIG. 1. The Z seam 100 is formed from a single piece of semi-rigid fibrous material with portions cut through in order to create precise folds so to create the needed structural rigidity. As illustrated, the Z seam 100 includes three main body portions 202, 204, and 206 that are stacked together when folded to add the needed structural rigidity. The folds are created by a partial depth incision 208 between body portions 202 and 204, and two “V” shaped reliefs 212 and 214 that meet at ridge line 216 when folded and create an end fold section 210 between body portions 204 and 206. Regarding the foldability of the Z seam, the remaining semi-rigid fibrous material 102 left at the bottoms of the partial depth incision 208 and the two “V” shaped reliefs 212 and 214 respectively act as living hinges along which the semi-rigid fibrous material 102 bends. Accordingly, when folded to the allowable extent of each living hinge, the body portions, 202, 204, and 206 along with the end fold section 210 assumes a “Z” shape in profile. To retain this shape after folding, this stack of material (i.e., body portions, 202, 204, and 206) is bonded in place down its length. The bonding can be achieved in a variety of manners. For instance, in certain embodiments, the boding can be achieved by stitching/sewing the sections together. In other embodiments, the sections can be welded together via other techniques.

As an aside, ridge line 216 in FIG. 2 is illustrated as a peak formed between the two “V” shaped reliefs 212 and 214. Ridge line 216 is not required to form a peak. In other embodiments, ridge line 216 could take the form of a flat/plateau rather than a peak/ridge. Still other structures are contemplated, and the disclosure contained herein is not limited as such.

FIG. 3 illustrates an unfolded embodiment of the Z seam 100. The unfolded Z seam 100 of FIG. 3 is identical to the folded Z seam of FIGS. 1 and 2. The unfolded Z seam 100 of FIG. 3 is provided to better illustrate the types of cuts used to create the partial depth incision 208 between body portions 202 and 204 and the two “V” shaped reliefs 212 and 214 that meet at ridge line 216 when folded and create an end fold section 210 between body portions 204 and 206. As shown, when the body portions 202, 204 and 206 are folded along the partial depth incision 208 and the two “V” shaped reliefs 212 and 214, the “Z” shaped structure of the Z seam 100 is formed.

FIGS. 1 and 2 illustrate just a single pieces of semi-rigid fibrous material 100 folded into Z seam 100. In certain embodiments, multiple pieces of semi-rigid fibrous material 100 may be joined together in order to create specific structures with adequate rigidity to satisfy the intended purpose of the structure. For instance, in certain embodiments, multiple Z seams 100 may be joined to form a cube or other such structure with sufficient structural rigidity to support structure associated with the cube, such as lighting elements (i.e., Light Emitting Diodes, etc.) disposed within the cube and supported by the Z seams 100 for suspension from a ceiling in a particular environment. To aid in joining one Z seam to another, a tertiary feature 218 is added to an end of the Z seam 100. This tertiary feature 218 may take the form of a tab or a cut out space (i.e., socket) formed by specifically cutting the semi-rigid fibrous material 102 to create the tab or to accommodate a tab from another structure. This tab/cut out space structure is used for alignment and/or joining between multiple pieces of semi-rigid fibrous material.

When the tertiary feature 218 is a tab, the structure of the tab can be in a variety of forms such as a rectangular protrusion in one embodiment or a hook shape in another embodiment. Correspondingly, if the tertiary feature 218 is a cut out space, the cut out space is specifically cut to accommodate the structure of the tab from the other corresponding structure to be joined to the Z seam 100. In this manner, multiple structures may be aligned, joined, attached, sinched, closed, or captured.

Additionally, other such embodiments of the tab 218 are contemplated beyond the rectangular protrusion or hook shape. Indeed, the shape of the tab and corresponding cut out space may be any shape that promotes better engagement. Further, other such additional feature may be added to the tab structure, such as holes and other such structures.

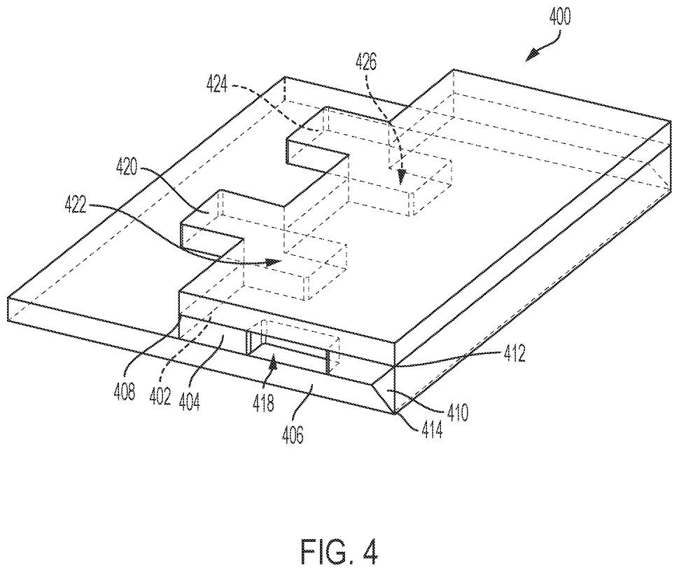

FIG. 4 illustrates a further embodiment of the Z seam 400. Z seam 400 includes structural elements 402-418 that corresponds to similar structure 202-218 illustrated in FIG. 2 of Z seam 100. Accordingly, the above description of that structure will not be repeated here for the sake of brevity. Beyond structural elements 402-418, the Z seam 400 further includes tab 420 with corresponding cutout 422 and tab 424 with corresponding cutout 426. As illustrated, tabs 420 and 424 protrude from body portion 402 and are cut out from body portion 404 such that when the Z seam 400 is folded the tabs 420 and 424 are created. Tabs 420 and 424 and cutouts 422 and 426 can be used for aligning, joining, attaching, sinching, closing, or capturing with a socket of another structure separate from the Z seam 400, similar to the tertiary feature 218 of FIG. 2, but from a side of the Z seam 400 rather than the end. Accordingly, in certain embodiments, the Z seam 400 may be joined to one or more secondary structures from multiple directions using both the tabs 420 and 424 and the tertiary feature 218. Further, while the illustrated embodiment shows two tabs 420 and 424 of the Z seam 400, more or less tabs are contemplated in certain other embodiments.

The G seam construction is comprised of 4 “V” shaped reliefs. The remaining material the bottom of each relief act as living hinges along which the panel bends. When folded to the allowable extent of each living hinge, the panel assumes a “G” shape in profile. This stack of material is bonded in place down its length, i.e., stitched, welded.

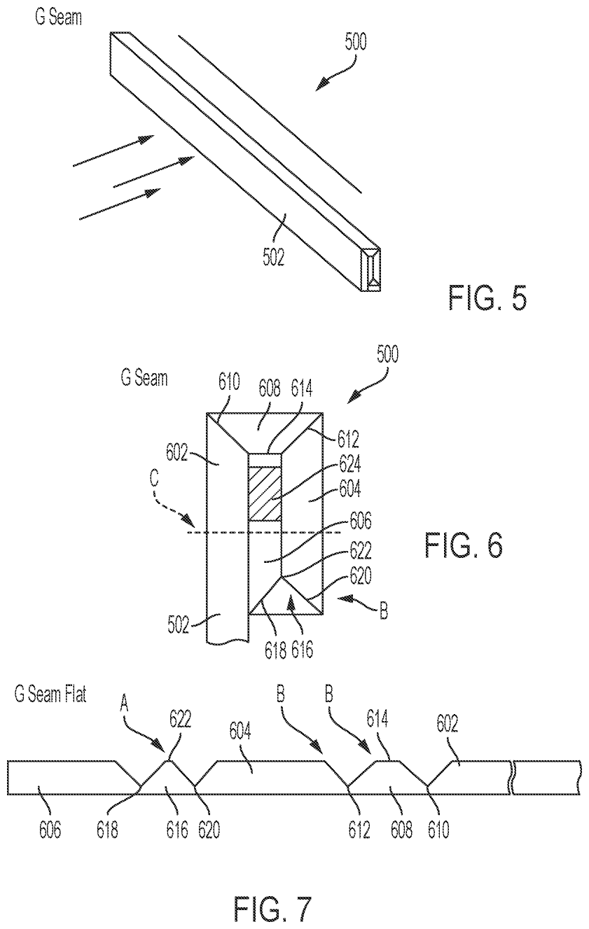

FIG. 5 illustrates a perspective view of a G seam support structure (G seam for short) 500, in accordance with embodiments of the disclosure. G seam 500 is formed using semi-rigid fibrous material 502 folded in a manner to increase the structural rigidity by reinforcing the semi-rigid fibrous material 502 with multiple layers. This structural rigidity using the G seam 500 is improved in both the lengthwise and perpendicular directions.

FIG. 6 illustrates a side view of the G seam 500 of FIG. 5. The G seam 500 is formed from a single piece of semi-rigid fibrous material with portions cut through in order to create precise folds so to create the needed structural rigidity. As illustrated, the G seam 500 includes three main body portions 602, 604, and 606 that are stacked together when folded to add the needed structural rigidity. The folds are created by four “V” shaped reliefs 610, 612, 618, and 620. “V” shaped reliefs 610 and 612 when folded create end portion 608 that includes a flat/plateau 614 between body portions 602 and 604, where the plateau 614 is wide enough to accommodate the thickness of body portion 606. “V” shaped reliefs 618 and 620 meet at ridge line 622 when folded and create an end fold section 616 between body portions 604 and 606. While ridge line 622 is illustrated as a peak formed between the two “V” shaped reliefs 618 and 620, ridge line 622 is not required to form a peak. In other embodiments, ridge line 622 could take the form of a flat/plateau rather than a peak/ridge. Still other structures are contemplated, and the disclosure contained herein is not limited as such.

Regarding the foldability of the G seam, the remaining semi-rigid fibrous material 502 left at the bottoms of the four “V” shaped reliefs 610, 612, 618, and 620 respectively act as living hinges along which the semi-rigid fibrous material 502 bends. Accordingly, when folded to the allowable extent of each living hinge, the body portions, 602, 604, and 606 along with the end fold sections 608 and 616 assumes a “G” shape in profile. To retain this shape after folding, this stack of material (i.e., body portions, 602, 604, and 606) is bonded in place down its length. The bonding can be achieved in a variety of manners. For instance, in certain embodiments, the boding can be achieved by stitching/sewing the sections together. In other embodiments, the sections can be welded together via other techniques.

FIG. 7 illustrates an unfolded embodiment of the G seam 500. The unfolded G seam 500 of FIG. 7 is identical to the folded G seam of FIGS. 5 and 6. The unfolded G seam 500 of FIG. 7 is provided to better illustrate: (1) the types of cuts used to create the two “V” shaped relief cuts 618 and 620 that meet at ridge 622 when folded and create the end fold section 616 between body portions 606 and 604, and (2) the two “V” shaped reliefs 610 and 612 that meet at plateau 614 when folded and create an end fold section 608 between body portions 604 and 602. As shown, when the body portions 602, 604 and 606 are folded along the four “V” shaped reliefs, the “G” shaped structure of the G seam 500 is formed.

FIGS. 5 and 6 illustrate just a single pieces of semi-rigid fibrous material 500 folded into G seam 100. In certain embodiments, multiple pieces of semi-rigid fibrous material 500 may be joined together in order to create specific structures with adequate rigidity to satisfy the intended purpose of the structure. For instance, in certain embodiments, multiple G seams 500 may be joined to form a cube or other such structure with sufficient structural rigidity to support structure associated with the cube, such as lighting elements (e.g., Light Emitting Diodes, etc.) disposed within the cube and supported by the G seams 500 for suspension from a ceiling in a particular environment. To join one G seam to another, a tertiary feature 624 is added to an end of the G seam 500. This tertiary feature 624 may take the form of a tab or a cut out space (i.e., socket) formed by specifically cutting the semi-rigid fibrous material 502 to create the tab or to accommodate a tab from another structure. When the tertiary feature 624 is a tab, the structure of the tab can be in a variety of forms such as a simple rectangular protrusion in one embodiment or a hook shape in another embodiment. Correspondingly, if the tertiary feature 624 is a cut out space, the cut out space is specifically cut to accommodate the structure of the tab from the other corresponding structure to be joined to the G seam 500. In this manner, multiple structures may be aligned, joined, attached, sinched, closed, or captured.

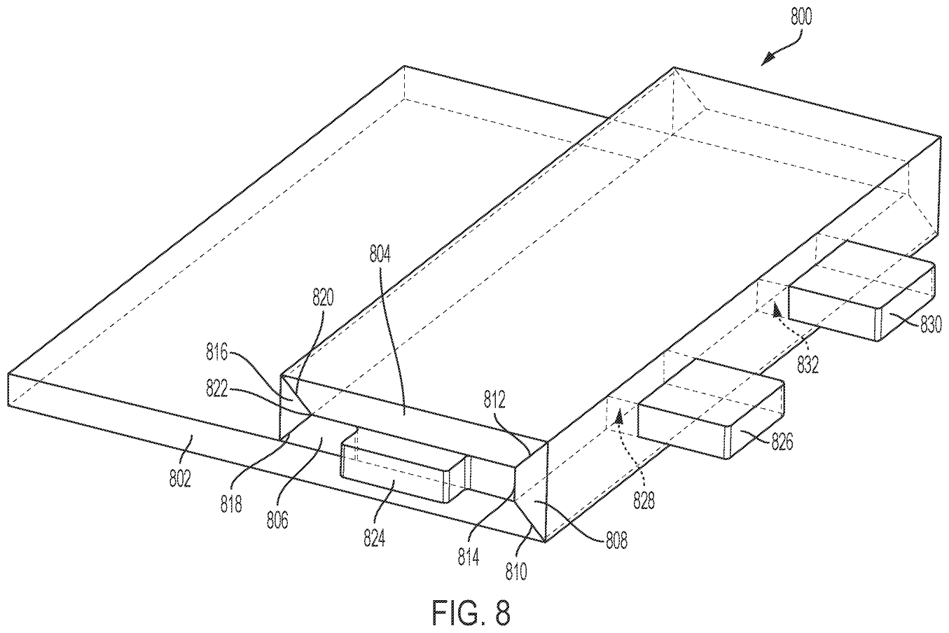

FIG. 8 illustrates a further embodiment of the G seam 800. G seam 800 includes structural elements 802-824 that corresponds to similar structure 602-624 illustrated in FIG. 6 of G seam 500. Accordingly, the above description of that structure will not be repeated here for the sake of brevity. Beyond structural elements 802-824, the G seam 800 further includes tab 826 with corresponding cutout 828 and tab 830 with corresponding cutout 832. As illustrated, tabs 826 and 830 protrude from body portion 806 and extend through cutout 828 and 830 cut out from end fold section 808. Tabs 826 and 830 can be used for aligning, joining, attaching, sinching, closing, or capturing with a socket of another structure separate from the G seam 800, similar to the tertiary feature 624 of FIG. 6, but from a side of the G seam 800 rather than the end. Accordingly, in certain embodiments, the G seam 800 may be joined to one or more secondary structures from multiple directions using both the tabs 826 and 830 and the tertiary feature 624. Further, while the illustrated embodiment shows two tabs 826 and 830 of the G seam 800, more or less tabs are contemplated in certain other embodiments.

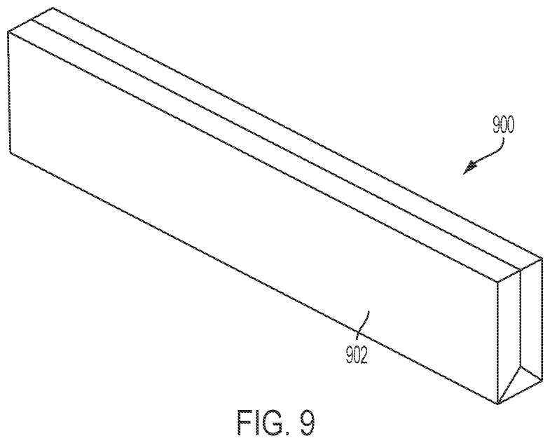

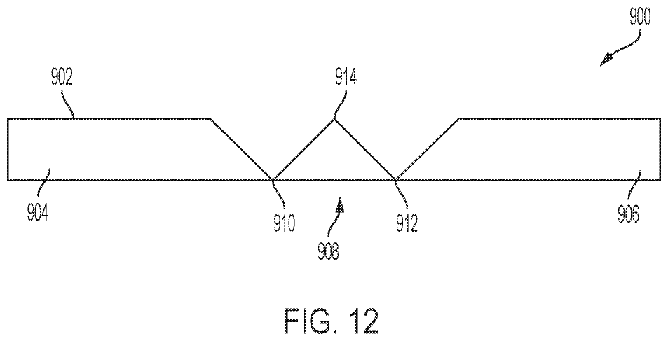

FIGS. 9-12 illustrate another embodiment of a seam support structure. Traditionally, a hem constitutes the edge of a piece of material which has been turned under and bonded to itself, often sewn. Due to material thickness and density, it is difficult to hem a semi-rigid fibrous panel. To achieve a hem with fibrous semi-rigid panels, “V” shaped reliefs are cut along a length of a semi-rigid fibrous panel. The leftover material at the apex of the cuts acts as a living hinge along with the portions fold, creating a C-shaped fold. This seam is then sewn together, resulting in a finished “edge” and a ledge upon which to locate tertiary features/support additional components (i.e. LED panels).

FIG. 9 illustrates a perspective view of a C seam support structure (C seam for short) 900, in accordance with embodiments of the disclosure. C seam 900 is formed using semi-rigid fibrous material 902 folded in a manner to increase the structural rigidity by reinforcing the semi-rigid fibrous material 902 with multiple layers. This structural rigidity using the C seam 900 is improved in both the lengthwise and perpendicular directions.

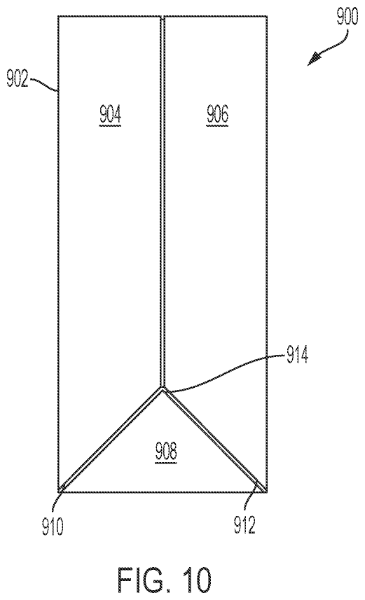

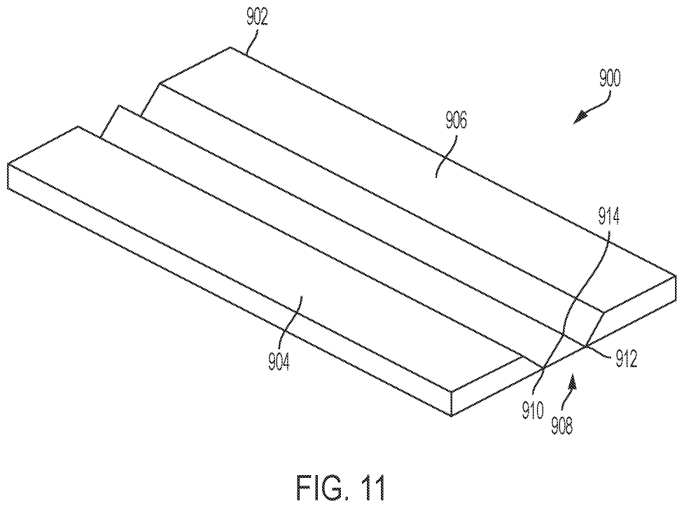

With reference to FIGS. 10-12 various views of the C seam 900 of FIG. 9 are further illustrated. The C seam 900 is formed from a single piece of semi-rigid fibrous material 902 with portions cut through in order to create precise folds so to create the needed structural rigidity. As illustrated, the C seam 900 includes two main body portions 904 and 906 that are stacked together when folded at a living hinge 908 to add the needed structural rigidity. The folds are created by two “V” shaped reliefs 910 and 912 that meet at ridge line 914 when folded and create the living hinge 908 between body portions 904 and 906.

Regarding the foldability of the C seam, the remaining semi-rigid fibrous material 102 left at the bottoms of the two “V” shaped reliefs 910 and 912 act as the living hinge 908 along which the semi-rigid fibrous material 102 bends. Accordingly, when folded to the allowable extent of the living hinge 908, the body portions 904 and 906 along with the living hinge 908 assumes a “C” shape in profile. To retain this shape after folding, this stack of material (i.e., body portions 904 and 906) is bonded in place down its length. The bonding can be achieved in a variety of manners. For instance, in certain embodiments, the boding can be achieved by stitching/sewing the sections together. In other embodiments, the sections can be welded together via other techniques.

As an aside, ridge line 914 is illustrated as a peak formed between the two “V” shaped reliefs 910 and 912. Ridge line 914 is not required to form a peak. In other embodiments, ridge line 914 could take the form of a flat/plateau rather than a peak/ridge. Still other structures are contemplated, and the disclosure contained herein is not limited as such.

Additionally, the C seam 900 may include alignment/joining tabs and corresponding cutouts similar to the Z and G seam embodiments discussed above. These alignment/joining tabs and cutouts function similarly to the discussion above and will not be repeated here for the sake of brevity.

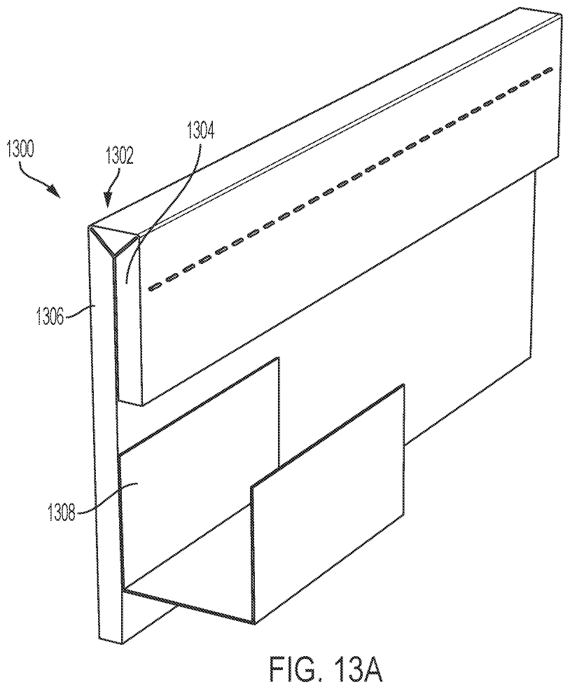

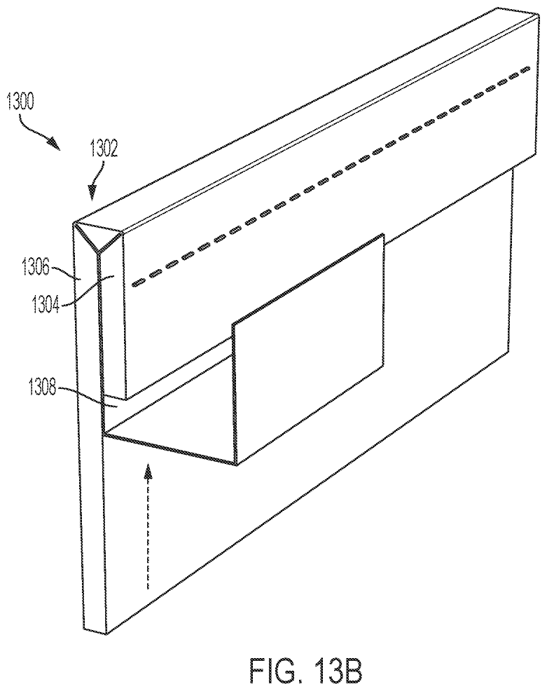

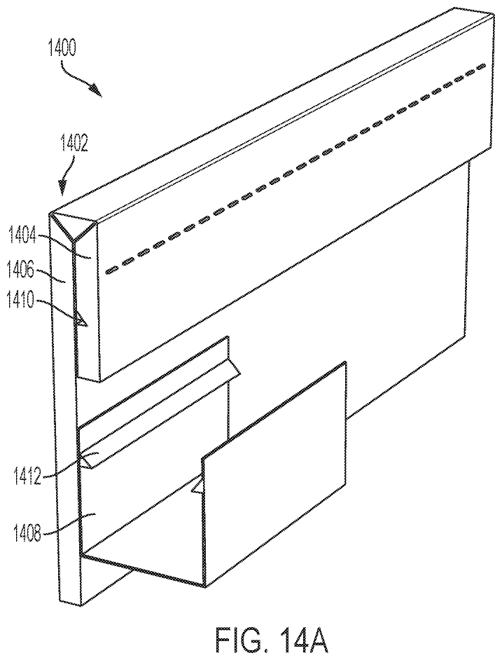

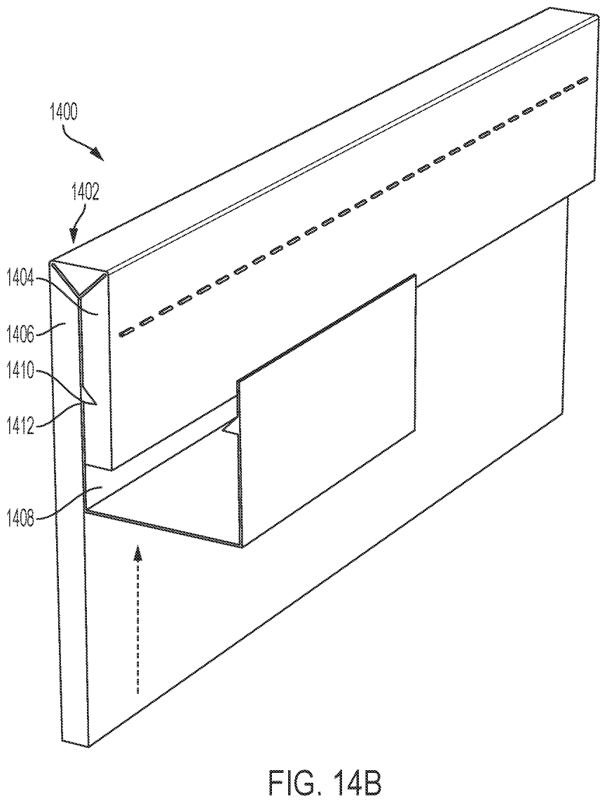

In certain embodiments, a seam formed via any of the above discussed embodiments, including the Z, G, and C seams of FIGS. 1-12 may be utilized to retain a secondary part. FIGS. 13a, 13b and 14a, 14b illustrate two embodiments of a seam utilized as a retaining structure.

FIGS. 13a and 13b illustrate a retaining structure 1300 formed using semi-rigid fibrous panel cut and folded into a C seam 1302. For the sake of brevity, the attendant description of the functionality and structure of the C seam 1302 will not be repeated in relation to FIGS. 13a and 13b. Rather, reference is made to the above description related to FIGS. 9-12 with respect to the structure and functionality of the C seam in general.

C seam 1302 includes body portions 1304 and 1306 that are adjacent to each other when the C seam 1302 is in the folded position. In the illustrated embodiment, body portions 1304 and 1306 are then sewn together once in the folded position such that a tension is created between coincident faces of the body portions 1304 and 1306. This tension between the coincident faces can be utilized to hold or grasp a secondary part 1308 even when the part itself is not captured in/under the stitch. The secondary part 1308 can be slid in between two coincident faces of the sewn seam where it is effectively clamped by the semi-rigid material on two sides of the coincident body portions 1304 and 1306.

FIGS. 14a and 14b illustrate a retaining structure 1400 formed using semi-rigid fibrous panel cut and folded into a C seam 1402. For the sake of brevity, the attendant description of the functionality and structure of the C seam 1402 will not be repeated in relation to FIGS. 14a and 14b. Rather, reference is made to the above description related to FIGS. 9-12 with respect to the structure and functionality of the C seam in general.

C seam 1402 includes body portions 1404 and 1406 that are adjacent to each other when the C seam 1402 is in the folded position. In the illustrated embodiment, body portions 1404 and 1406 are then sewn together once in the folded position such that a tension is created between coincident faces of the body portions 1404 and 1406. This tension between the coincident faces can be utilized to hold or grasp a secondary part 1408 even when the part itself is not captured in/under the stitch. The secondary part 1408 can be slid in between two coincident faces of the sewn seam where it is effectively clamped by the semi-rigid material on two sides of the coincident body portions 1404 and 1406.

In the illustrated embodiment of retaining structure 1400, a V-shaped relief 1410 is added/cut from an interior of the seam/mated faces of body portions 1404 and 1406. The V-shaped relief 1410 may be formed in either body portion 1404 or body portion 1406 or both dependent on a corresponding hook or similar structure being formed on the secondary part 1408. In the illustrated embodiment, a hook 1412 is shown. The V-shaped relief 1410 acts as a cavity into which the hook 1412 (or like-geometry) may grab or rest, resulting in a more secure hold of the secondary part 1408.

As an aside, with respect to 13a, 13b and 14a, 14b other methods of joining body portions 1304 and 1306 and body portions 1404 and 1406 rather than sewing are contemplated. For example, adhesives, such as an adhesive tape may be used to join the bodies. Indeed, any method of joining semi-rigid fibrous panel is contemplated.

As used herein, semi-rigid fibrous panel may be made from sew-able substrates and may be any sew-able fibrous body capable of being sewn to another similar such material. For instance, sew-able substrates may include non-woven felts (e.g., architectural acoustic panels and PET), soft plastics/rubbers, foams of varying density whether synthetic or natural, or any other such similar material.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A semi-rigid fibrous body comprising:
a first body portion;
a second body portion;
a partial depth incision in the semi-rigid fibrous body between the first body portion and the second body portion;
a third body portion; and
two “V” shaped reliefs cut into the semi-rigid fibrous body between the second body portion and the third body portions,
wherein the partial depth incision and the two “V” shaped reliefs are living hinges formed of the semi-rigid fibrous body.

2. A semi-rigid fibrous body comprising:
a first body portion;
a second body portion;
a first set of “V” shaped reliefs cut into the semi-rigid fibrous body between the first body portion and the second body portion;
a third body portion; and
a second set of “V” shaped reliefs cut into the semi-rigid fibrous body between the second body portion and the third body portion,
wherein the first set of “V” shaped reliefs and the second set of “V” shaped reliefs are living hinges formed of the semi-rigid fibrous body,
wherein a plateau is formed between each “V” shaped relief of the second set of “V” shaped reliefs, and
wherein a width of the plateau is the same as a thickness of the first body portion.

3. A semi-rigid fibrous structure comprising:
a first semi-rigid fibrous body comprising a tab; and
a second semi-rigid fibrous body comprising a socket,
wherein the tab of the first semi-rigid fibrous body and the socket of the second semi-rigid fibrous body are sized to accommodate alignment between the first semi-rigid fibrous body and the second semi-rigid fibrous body.

4. A semi-rigid fibrous body comprising:
a first body portion;
a second body portion; and
two “V” shaped reliefs cut into the semi-rigid fibrous body between the first body portion and the second body portion,
wherein the two “V” shaped reliefs form a living hinge in the semi-rigid fibrous body.
